(19) United States
(12) Patent Application Publication
(10) Pub. No.: US 2025/0103459 A1
(43) Pub. Date: Mar. 27, 2025

(54) METHODS AND APPARATUSES FOR TRAINING BEHAVIOR PREDICTION MODEL

(71) Applicant: ANT WEALTH (SHANGHAI) FINANCIAL INFORMATION SERVICES CO., LTD., Shanghai (CN)

(72) Inventors: Xiaojing LI, Shanghai (CN); Tao XU, Shanghai (CN); Fei YU, Shanghai (CN); Xin LU, Shanghai (CN)

(21) Appl. No.: 18/974,628

(22) Filed: Dec. 9, 2024

Related U.S. Application Data
(63) Continuation of application No. PCT/CN2023/130960, filed on Nov. 10, 2023.

(30) Foreign Application Priority Data
Nov. 29, 2022 (CN) 202211513095.8

(51) Int. Cl. G06F 11/34; G06F 7/548

(52) U.S. Cl. CPC G06F 11/3447; G06F 7/548; G06F 11/3438; G06F 2101/04

(57) ABSTRACT

Implementations of the present specification provide methods and apparatuses for training a behavior prediction model. In the implementations of the present specification, a sequence (a behavior sequence of a user) that includes multiple behavior types is split according to behavior types to obtain multiple single-behavior sequences. Time coding is performed on all time points of each of the multiple single-behavior sequences, to obtain multiple single-behavior time sequences corresponding to the multiple single-behavior sequences. Each single-behavior time sequence in the multiple single-behavior time sequences is modeled by using a behavior prediction model, and attention is paid to all time points of each single-behavior time sequence in the multiple single-behavior time sequences, so as to obtain a distribution situation of behaviors corresponding to the multiple single-behavior time sequences in terms of time as predicted by the behavior prediction model. The behavior prediction model is trained based on a loss value between the distribution situation of the behaviors corresponding to the multiple single-behavior time sequences in terms of time and the multiple single-behavior time sequences.

### TECHNICAL FIELD

One or more implementations of the present specification relate to the field of computer technologies, and more specifically, to methods and apparatuses for training a behavior prediction model in the field of computer technologies.

### BACKGROUND

In daily production or life, users often perform various behaviors. Through data analysis techniques, people can perform analysis and processing on a historical behavior of a user, so as to predict a time at which a future behavior of the user occurs. For example, products that a user has previously clicked can be organized into a time sequence of click behaviors in the order of the time of the clicks. By analyzing the time sequence of the click behaviors, a time at which the user will click a product in the future can be predicted.

For a multi-behavior sequence of a user in an uneven continuous time domain, a conventional behavior sequence modeling method is to discretize the multi-behavior sequence into behaviors in multiple even time intervals, and time aggregation is performed on multiple behaviors in each time interval to obtain a corresponding feature. In the above manner, in a process of processing the multi-behavior sequences, original time information of each behavior in the multi-behavior sequences is obfuscated. As such, the multi-behavior sequence obtained through modeling is relatively different from the original behavior sequence (unprocessed multi-behavior sequence). This results in inaccurate time and type of a future behavior predicted by using the modeled multi-behavior sequence.

### SUMMARY

One or more implementations of the present specification provide methods and apparatuses for training a behavior prediction model, and the methods can accurately model time point information of each behavior in a multi-behavior sequence of a user.

According to a first aspect, a method for training a behavior prediction model is provided, where the method includes: splitting a behavior sequence of a user to obtain multiple single-behavior sequences, each single-behavior sequence being corresponding to one behavior, and being used to record a correspondence between the behavior and a time point; performing time coding on the multiple single-behavior sequences to obtain multiple single-behavior time sequences of the multiple single-behavior sequences; inputting the multiple single-behavior time sequences into a behavior prediction model, so the behavior prediction model performs modeling of the time point for each single-behavior time sequence in the multiple single-behavior time sequences to obtain a distribution situation of behaviors corresponding to the multiple single-behavior time sequences in terms of time; and training the behavior prediction model based on a first loss value between the distribution situation of the behaviors corresponding to the multiple single-behavior time sequences in terms of time and the multiple single-behavior time sequences, the behavior prediction model being used to predict a time point and a type of at least one future behavior of the user based on the behavior sequence of the user.

In the technical solution herein, in one or more implementations of the present specification, a behavior sequence of a user is split to obtain multiple single-behavior sequences; time coding is performed on all time points in the multiple single-behavior sequences to obtain multiple single-behavior time sequences of the multiple single-behavior sequences; the multiple single-behavior time sequences are input into a behavior prediction model, to obtain a distribution situation, predicted by the behavior prediction model, of behaviors corresponding to the multiple single-behavior time sequences in terms of time; and the behavior prediction model is trained based on a first loss value between the distribution situation of the behaviors corresponding to the multiple single-behavior time sequences in terms of time and the multiple single-behavior time sequences. For example, the behavior prediction model pays attention to each time point of multiple single behaviors in the behavior sequence of the user, and models each time point. Therefore, a more accurate behavior prediction model can be obtained through modeling, and a more accurate time point and type of a future behavior can be predicted by using the behavior prediction model.

With reference to the first aspect, in some possible implementations, the splitting the behavior sequence of the user to obtain the multiple single-behavior sequences includes: splitting the behavior sequence of the user according to behavior types to obtain the multiple single-behavior sequences, where the behavior sequence of the user corresponds to multiple behavior types.

In the technical solution herein, because the behavior sequence of the user is corresponding to multiple behavior types, the behavior sequence of the user can be split into multiple single-behavior sequences according to the behavior types, and each single behavior in multiple single behaviors is corresponding to one behavior type. Therefore, time coding can be performed on the multiple single-behavior sequences to obtain multiple single-behavior time sequences of the multiple single-behavior sequences, so the multiple single-behavior time sequences can be used to train the behavior prediction model.

With reference to the first aspect and the implementations herein, in some possible implementations, the performing time coding on the multiple single-behavior sequences to obtain the multiple single-behavior time sequences of the multiple single-behavior sequences includes: performing time coding on the multiple single-behavior sequences by using a trigonometric function, to obtain the multiple single-behavior time sequences.

In the technical solution herein, time coding is performed on the multiple single-behavior sequences by using the trigonometric function, and all time features of each single-behavior sequence in the multiple single-behavior sequences in terms of time can be obtained, so as to obtain multiple single-behavior time sequences of the multiple single-behavior sequences.

With reference to the first aspect and the implementations herein, in some possible implementations, that the behavior prediction model performs modeling of the time point for each single-behavior time sequence in the multiple single-behavior time sequences to obtain the distribution situation of the behaviors corresponding to the multiple single-behavior time sequences in terms of time includes: The behavior prediction model performs modeling of a strength value of the time point in a predetermined time period for each single-behavior time sequence in the multiple single-behavior time sequences, to obtain the distribution situation of the behaviors corresponding to the multiple single-behavior time sequences in terms of time.

It should be understood that the technical solution herein is to obtain the distribution situation of the behaviors corresponding to the multiple single-behavior time sequences in terms of time, and is actually to obtain a probability density distribution function of the behaviors corresponding to the multiple single-behavior time sequences in a time period.

With reference to the first aspect and the implementations herein, in some possible implementations, the behavior prediction model includes a behavior time sub-model, and the inputting the multiple single-behavior time sequences into the behavior prediction model, so the behavior prediction model performs modeling of the time point for each single-behavior time sequence in the multiple single-behavior time sequences to obtain the distribution situation of the behaviors corresponding to the multiple single-behavior time sequences in terms of time includes: inputting the multiple single-behavior time sequences into the behavior time sub-model in the behavior prediction model, and performing, by the behavior time sub-model, modeling of the time point for each single-behavior time sequence in the multiple single-behavior time sequences to obtain the distribution situation of the behaviors corresponding to the multiple single-behavior time sequences in terms of time.

In the technical solution herein, in a case in which the behavior prediction model includes the behavior time sub-model, the behavior time sub-model is, for example, trained by using the first loss value between the multiple single-behavior time sequences and the distribution situation of the behaviors corresponding to the multiple single-behavior time sequences in terms of time. The distribution situation of the behaviors corresponding to the multiple single-behavior time sequences in terms of time is obtained by the behavior time sub-model by modeling the time point for the multiple single-behavior time sequences.

With reference to the first aspect and some implementations herein, in some possible implementations, the training the behavior prediction model based on the first loss value between the distribution situation of the behaviors corresponding to the multiple single-behavior time sequences in terms of time and the multiple single-behavior time sequences includes: training the behavior time sub-model in the behavior prediction model based on the first loss value between the distribution situation of the behaviors corresponding to the multiple single-behavior time sequences in terms of time and the multiple single-behavior time sequences.

In some technical solution herein, the behavior prediction model is trained based on the first loss value. As such, the obtained behavior prediction model can better predict time and a type of a future behavior based on a behavior sequence to be predicted.

With reference to the first aspect and the implementations herein, in some possible implementations, the behavior prediction model further includes a behavior relationship sub-model and a prediction sub-model, and the method further includes: inputting the multiple single-behavior sequences into the behavior relationship sub-model to obtain causality between every two single-behavior sequences in the multiple single-behavior sequences, where the causality is used to represent a relationship between occurrence of a behavior in one single-behavior sequence and occurrence of a behavior in another single-behavior sequence in every two single-behavior sequences; inputting, into the prediction sub-model, the causality between every two single-behavior sequences in the multiple single-behavior sequences and the distribution situation of the behaviors corresponding to the multiple single-behavior time sequences in terms of time, and performing, by the prediction sub-model, sequence prediction based on the causality and the distribution situation to obtain a predicted behavior sequence; and training the behavior relationship sub-model and the prediction sub-model based on the first loss value and a second loss value between the predicted behavior sequence and the behavior sequence of the user.

In the technical solution herein, when the behavior prediction model further includes the behavior relationship sub-model and the prediction sub-model, the multiple single-behavior sequences can be input into the behavior relationship sub-model, to obtain the causality between every two single-behavior sequences in the multiple single-behavior sequences; and the causality between every two single-behavior sequences in the multiple single-behavior sequences and the distribution situation of the behaviors corresponding to the multiple single-behavior time sequences in terms of time are input into the prediction sub-model, so as to obtain the predicted behavior sequence by using the prediction sub-model. Therefore, the behavior relationship sub-model and the prediction sub-model are trained based on the first loss value and the second loss value between the predicted behavior sequence and the behavior sequence of the user. For example, the behavior prediction model not only pays attention to the time point information of the behavior sequence of the user, but also pays attention to causality between multiple behaviors in the behavior sequence of the user, so the behavior sequence of the user can be more accurately modeled.

With reference to the first aspect and the implementations herein, in some possible implementations, the inputting the multiple single-behavior sequences into the behavior relationship sub-model to obtain the causality between every two single-behavior sequences in the multiple single-behavior sequences includes: obtaining the causality between every two single-behavior sequences in the multiple single-behavior sequences according to a sum of covariance values of every two single-behavior sequences in the multiple single-behavior sequences at all time points.

It should be understood that the obtaining the causality between every two single-behavior sequences in the multiple single-behavior sequences is determining Granger causality between every two single-behavior sequences.

With reference to the first aspect and the implementations herein, in some possible implementations, the training the behavior relationship sub-model and the prediction sub-model based on the first loss value and the second loss value between the predicted behavior sequence and the behavior sequence of the user includes: determining a third loss value between a prediction label and a real label of the behavior sequence of the user, where the real label is used to indicate real information of the user, and the prediction label is used to indicate information of the user predicted by the prediction sub-model; obtaining a fourth loss value by averaging the second loss value and the third loss value; and training the behavior relationship sub-model and the prediction sub-model based on the first loss value and the fourth loss value.

In the technical solution herein, in comparison with training of the behavior relationship sub-model and the prediction sub-model based only on the first loss value and the second loss value, the technical solution further introduces the third loss value between the prediction label and the real label. The average value between the third loss value and the second loss value is determined as the fourth loss value, and the behavior relationship sub-model and the prediction sub-model are trained based on the first loss value and the fourth loss value. In this solution, the third loss value is introduced, which is equivalent to introducing more information to train the behavior relationship sub-model and the prediction sub-model. As such, the obtained behavior relationship sub-model and prediction sub-model are more accurate.

With reference to the first aspect and the implementations herein, in some possible implementations, the method further includes: before the determining the third loss value between the prediction label and the real label of the behavior sequence of the user, inputting, into the prediction sub-model, the causality between every two single-behavior sequences in the multiple single-behavior sequences and the distribution situation of the behaviors corresponding to the multiple single-behavior time sequences in terms of time, to obtain the prediction label corresponding to the behavior sequence of the user.

With reference to the first aspect and the implementations herein, in some possible implementations, the training the behavior relationship sub-model and the prediction sub-model based on the first loss value and the second loss value between the predicted behavior sequence and the behavior sequence of the user includes: obtaining a fifth loss value according to the first loss value and the second loss value; and training the behavior relationship sub-model based on the fifth loss value, and training the prediction sub-model based on the second loss value.

With reference to the first aspect and the implementations herein, in some possible implementations, the obtaining the fifth loss value according to the first loss value and the second loss value includes: determining a first value according to a matrix formed by a second-order partial derivation of each weight in the relationship sub-model and a vector formed by each weight in the relationship sub-model; and obtaining the fifth loss value according to the first value, the first loss value, and the second loss value.

It should be understood that the process herein of determining the first value is implemented by using a Pareto optimality solution principle.

With reference to the first aspect and the implementations herein, in some possible implementations, the method further includes: inputting a behavior sequence to be predicted into the behavior prediction model to obtain a time point and a type corresponding to at least one future behavior of the behavior sequence to be predicted as predicted by the behavior prediction model.

In summary, one or more implementations of the present specification provide a method for training a behavior prediction model. A behavior sequence of a user is split to obtain multiple single-behavior sequences; time coding is performed on all time points in the multiple single-behavior sequences to obtain multiple single-behavior time sequences of the multiple single-behavior sequences; the multiple single-behavior time sequences are input into a behavior prediction model, to obtain a distribution situation, predicted by the behavior prediction model, of behaviors corresponding to the multiple single-behavior time sequences in terms of time; and the behavior prediction model is trained based on a first loss value between the distribution situation of the behaviors corresponding to the multiple single-behavior time sequences in terms of time and the multiple single-behavior time sequences. In some implementations, the behavior prediction model pays attention to each piece of time point information of multiple single behaviors in the behavior sequence of the user, and models each time point. However, to avoid the original time information of each behavior in the multi-behavior sequence from being obfuscated in a related technology, a more accurate behavior prediction model can be obtained through modeling, and the behavior prediction model can be used to predict a more accurate time point and type of a future behavior.

In addition, when the behavior prediction model includes the behavior time sub-model, the behavior relationship sub-model, and the prediction sub-model, the multiple single-behavior sequences can be input into the behavior relationship sub-model, to obtain the causality between every two single-behavior sequences in the multiple single-behavior sequences; and the causality between every two single-behavior sequences in the multiple single-behavior sequences and the distribution situation of the behaviors corresponding to the multiple single-behavior time sequences in terms of time are input into the prediction sub-model, so as to obtain the predicted user sequence by using the prediction sub-model. Therefore, the behavior relationship sub-model and the prediction sub-model are trained based on the first loss value and the second loss value between the predicted behavior sequence and the behavior sequence of the user. In some implementations, the behavior prediction model not only pays attention to the time point information of the behavior sequence of the user, but also pays attention to causality between multiple behaviors in the behavior sequence of the user, so the behavior sequence of the user can be more accurately modeled.

Finally, a time point and a type corresponding to at least one future behavior of the behavior sequence to be predicted can be predicted by using the obtained behavior prediction model.

According to a second aspect, an apparatus for training a behavior prediction model is provided, where the apparatus includes: a determining module, configured to split a behavior sequence of a user to obtain multiple single-behavior sequences, each single-behavior sequence being corresponding to one behavior, and being used to record a correspondence between the behavior and a time point; the determining module being further configured to perform time coding on the multiple single-behavior sequences to obtain multiple single-behavior time sequences of the multiple single-behavior sequences; the determining module being further configured to input the multiple single-behavior time sequences into a behavior prediction model, so the behavior prediction model performs modeling of the time point for each single-behavior time sequence in the multiple single-behavior time sequences to obtain a distribution situation of behaviors corresponding to the multiple single-behavior time sequences in terms of time; and a training module, configured to train the behavior prediction model based on a first loss value between the distribution situation of the behaviors corresponding to the multiple single-behavior time sequences in terms of time and the multiple single-behavior time sequences, the behavior prediction model being used to predict a time point and a type of at least one future behavior of the user based on the behavior sequence of the user.

With reference to the second aspect, in some possible implementations, the determining module is configured to split the behavior sequence of the user according to behavior types to obtain the multiple single-behavior sequences, where the behavior sequence of the user corresponds to multiple behavior types.

With reference to the second aspect and the implementation herein, in some possible implementations, the determining module is further configured to perform time coding on the multiple single-behavior sequences by using a trigonometric function, to obtain the multiple single-behavior time sequences.

With reference to the second aspect and the implementations herein, in some possible implementations, the determining module is further configured to: perform, by using the behavior prediction model, modeling of a strength value of the time point in a predetermined time period for each single-behavior time sequence in the multiple single-behavior time sequences, to obtain the distribution situation of the behaviors corresponding to the multiple single-behavior time sequences in terms of time.

It should be understood that the solution herein is to obtain the distribution situation of the behaviors corresponding to the multiple single-behavior time sequences in terms of time, and is actually to obtain a probability density distribution function of the behaviors corresponding to the multiple single-behavior time sequences in a time period.

With reference to the second aspect and the implementations herein, in some possible implementations, the behavior prediction model includes a behavior time sub-model, and the determining module is, in some implementations, further configured to: input the multiple single-behavior time sequences into the behavior time sub-model in the behavior prediction model, and perform, by the behavior time sub-model, modeling of the time point for each single-behavior time sequence in the multiple single-behavior time sequences to obtain the distribution situation of the behaviors corresponding to the multiple single-behavior time sequences in terms of time.

With reference to the second aspect and the implementations herein, in some possible implementations, the training module is configured to train the behavior time sub-model in the behavior prediction model based on the first loss value between the distribution situation of the behaviors corresponding to the multiple single-behavior time sequences in terms of time and the multiple single-behavior time sequences.

With reference to the second aspect and the implementations herein, in some possible implementations, the behavior prediction model further includes a behavior relationship sub-model and a prediction sub-model, and the determining module is further configured to: input the multiple single-behavior sequences into the behavior relationship sub-model to obtain causality between every two single-behavior sequences in the multiple single-behavior sequences, where the causality is used to represent a relationship between occurrence of a behavior in one single-behavior sequence and occurrence of a behavior in another single-behavior sequence in every two single-behavior sequences; and input, into the prediction sub-model, the causality between every two single-behavior sequences in the multiple single-behavior sequences and the distribution situation of the behaviors corresponding to the multiple single-behavior time sequences in terms of time, and perform, by the prediction sub-model, sequence prediction based on the causality and the distribution situation to obtain a predicted behavior sequence; and the training module is further configured to: train the behavior relationship sub-model and the prediction sub-model based on the first loss value and a second loss value between the predicted behavior sequence and the behavior sequence of the user.

With reference to the second aspect and the implementations herein, in some possible implementations, the determining module is further configured to obtain the causality between every two single-behavior sequences in the multiple single-behavior sequences according to a sum of covariance values of every two single-behavior sequences in the multiple single-behavior sequences at all time points.

With reference to the second aspect and the implementations herein, in some possible implementations, the training module is further configured to: determine a third loss value between a prediction label and a real label of the behavior sequence of the user, where the real label is used to indicate real information of the user, and the prediction label is used to indicate information of the user predicted by the prediction sub-model; obtain a fourth loss value by averaging the second loss value and the third loss value; and train the behavior relationship sub-model and the prediction sub-model based on the first loss value and the fourth loss value.

With reference to the second aspect and the implementations herein, in some possible implementations, the determining module is further configured to: input, into the prediction sub-model, the causality between every two single-behavior sequences in the multiple single-behavior sequences and the distribution situation of the behaviors corresponding to the multiple single-behavior time sequences in terms of time, to obtain the prediction label corresponding to the behavior sequence of the user.

With reference to the second aspect and the implementations herein, in some possible implementations, the training module is further configured to: obtain a fifth loss value according to the first loss value and the second loss value; and train the behavior relationship sub-model based on the fifth loss value, and train the prediction sub-model based on the second loss value.

With reference to the second aspect and the implementations herein, in some possible implementations, the determining module is further configured to: determine a first value according to a matrix formed by a second-order partial derivation of each weight in the relationship sub-model and a vector formed by each weight in the relationship sub-model; and obtain the fifth loss value according to the first value, the first loss value, and the second loss value.

It should be understood that the process herein of determining the first value is implemented by using a Pareto optimality solution principle.

With reference to the second aspect and the implementations herein, in some possible implementations, the determining module is further configured to: input a behavior sequence to be predicted into the behavior prediction model to obtain a time point and a type corresponding to at least one future behavior of the behavior sequence to be predicted as predicted by the behavior prediction model.

According to a third aspect, an electronic device is provided, including a memory, a processor, and a computer program stored in the memory and running on the processor, where when the processor executes the computer program, the electronic device is enabled to perform the method in any one of the first aspect or the possible implementations of the first aspect.

According to a fourth aspect, a computer-readable storage medium is provided, where the computer-readable storage medium stores instructions, and when the instructions run on a computer or a processor, the computer or the processor is enabled to perform the method in any one of the first aspect or the possible implementations of the first aspect.

According to a fifth aspect, a computer program product including instructions is provided. When the computer program product runs on a computer or a processor, the computer or the processor is enabled to perform the method in any one of the first aspect or the possible implementations of the first aspect.

### BRIEF DESCRIPTION OF DRAWINGS

FIG. 1 is a schematic diagram of performing time aggregation on a multi-behavior sequence according to one or more implementations of the present specification.

FIG. 2 is a schematic flowchart illustrating a method for training a behavior prediction model according to one or more implementations of the present specification.

FIG. 3 is a schematic diagram of splitting a behavior sequence of a user according to one or more implementations of the present specification.

FIG. 4 is a schematic structural diagram illustrating a behavior prediction model according to one or more implementations of the present specification.

FIG. 5 is a schematic structural diagram illustrating an apparatus for training a behavior prediction model according to one or more implementations of the present specification.

FIG. 6 is a schematic structural diagram illustrating an electronic device, according to one or more implementations of the present specification.

### DESCRIPTION OF EMBODIMENTS

The following clearly and thoroughly describes the technical solutions in one or more implementations of the present specification with reference to the accompanying drawings. In the description of one or more implementations of the present specification, “multiple” refers to two or more than two. The terms “first” and “second” are merely used for description, and shall not be understood as an indication or implication of relative importance or implicit indication of the number of indicated technical features. Therefore, a feature limited by “first” or “second” can explicitly or implicitly include one or more such features. “and/or” in the present specification is merely an association relationship between associated objects, and represents that three relationships can exist. For example, A and/or B can represent the following three cases: Only A exists, both A and B exist, and only B exists.

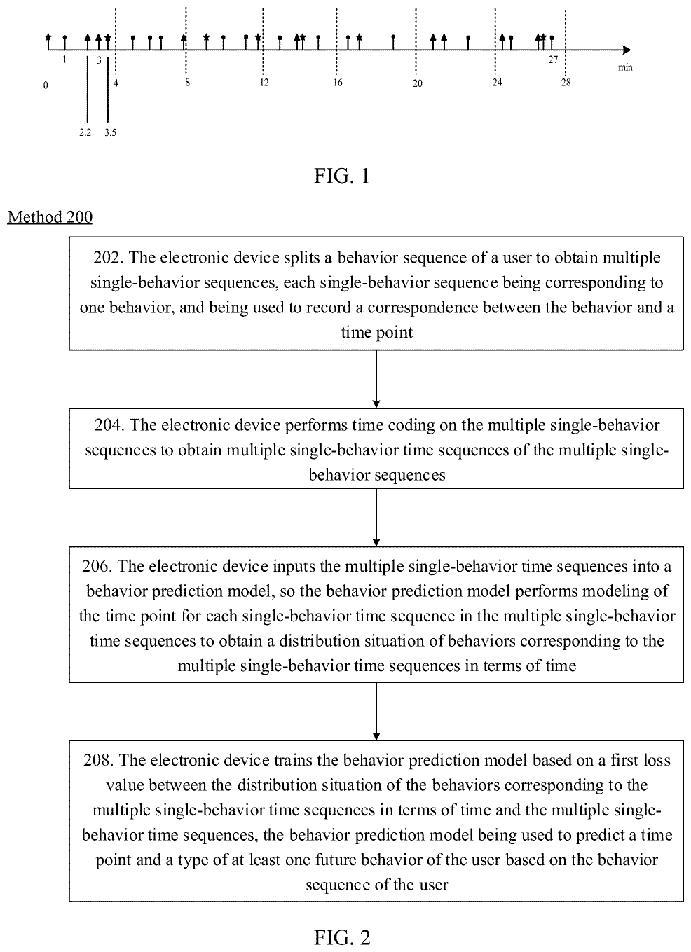

FIG. 1 is a schematic diagram of performing time aggregation on a multi-behavior sequence according to one or more implementations of the present specification.

For example, in a multi-behavior sequence shown in FIG. 1, the multi-behavior sequence is corresponding to multiple behavior types, and each behavior of a type is corresponding to a time point. As shown in FIG. 1, at a time point of the 0th minute, it is a pentagonal type of behavior; at a time point of the 1st minute, it is a circular type of behavior; at a time point of the 2.2nd minute, it is a triangular type of behavior; at a time point of the 3rd minute, it is a triangular type of behavior; at a time point of the 3.5th minute, it is a pentagonal type of behavior; and, at the last time point of the 27th minute, it is a rectangular type of behavior. The pentagonal type is an online-purchase type, the circular type is a transfer type, the triangular type is a fund subscription type, and the rectangular type is a chat type.

In a related technology, for the multi-behavior sequence shown in FIG. 1, the multi-behavior sequence is equally divided according to a predetermined time interval, to obtain behavior sequences in multiple even time periods. Time aggregation is performed on behavior sequences in each time period of the behavior sequences in the multiple even time periods, and a quantity of times of occurrence of each behavior in each time period is obtained. Assume that the predetermined time interval is 4 minutes, and the following is obtained after the multi-behavior sequence is equally divided and time aggregation: 0-4 minutes: 2 online purchase behaviors, 1 transfer behavior, 2 fund subscription behaviors, and 0 chat behaviors; 4-8 minutes: 0 online purchases, 1 transfer behavior, 1 fund subscription behavior, and 2 chat behaviors; 8-12 minutes: 2 online purchase behaviors, 1 transfer behavior, 0 fund subscription behaviors, and 1 chat behavior; 12-16 minutes: 1 online purchase behavior, 1 transfer behavior, 1 fund subscription behavior, and 1 chat behavior; 16-20 minutes: 1 online purchase behavior, 2 transfer behaviors, 0 fund subscription behaviors, and 0 chat behaviors; 20-24 minutes: 0 online purchase behaviors, 0 transfer behaviors, 2 fund subscription behaviors, and 1 chat behavior; and 24-28 minutes: 1 online purchase behavior, 0 transfer behaviors, 2 fund subscription behaviors, and 2 chat behaviors.

According to the rule of the multi-behavior sequence collected every 4 minutes, the prediction yields a time period of occurrence of a specific type of behavior in the future, rather than a time point. Therefore, the prediction manner is inaccurate in predicting time information of occurrence of a future behavior.

FIG. 2 is a schematic flowchart illustrating a method for training a behavior prediction model according to one or more implementations of the present specification.

It should be understood that the method for training a behavior prediction model provided in one or more implementations of the present specification can be applied to any electronic device, and the electronic device can be a computer terminal (a display device or a mobile phone terminal having a data processing function), a server, etc.

It should be further understood that, in one or more implementations of the present specification, a process of determining the behavior prediction model is implemented based on a recurrent neural network (RNN) in deep learning, which can be, for example, a long short term memory (LSTM) unit, a gated recurrent unit (GRU), etc.

For example, as shown in FIG. 2, the method 200 includes step 202 to step 208.

In step 202, the electronic device splits a behavior sequence of a user to obtain multiple single-behavior sequences, each single-behavior sequence being corresponding to one behavior, and being used to record a correspondence between the behavior and a time point.

It should be understood that the multi-behavior sequence shown in FIG. 1 is used as an illustrative example of a the behavior sequence of a user for descriptive purposes. Same as the multi-behavior sequence, the behavior sequence of the user corresponds to multiple types of behaviors.

It should be further understood that each behavior of a type in the behavior sequence of the user has a corresponding time point, e.g., a specific occurrence time of a specific behavior of a type.

In a possible implementation, step 202 includes: The electronic device splits the behavior sequence of the user according to behavior types to obtain the multiple single-behavior sequences, where the behavior sequence of the user corresponds to multiple behavior types.

In the technical solution herein, because the behavior sequence of the user is corresponding to multiple behavior types, the behavior sequence of the user can be split into multiple single-behavior sequences according to the behavior types, and each single behavior in multiple single behaviors is corresponding to one behavior type. Therefore, time coding can be performed on the multiple single-behavior sequences to obtain multiple single-behavior time sequences of the multiple single-behavior sequences, so the multiple single-behavior time sequences can be used to train the behavior prediction model.

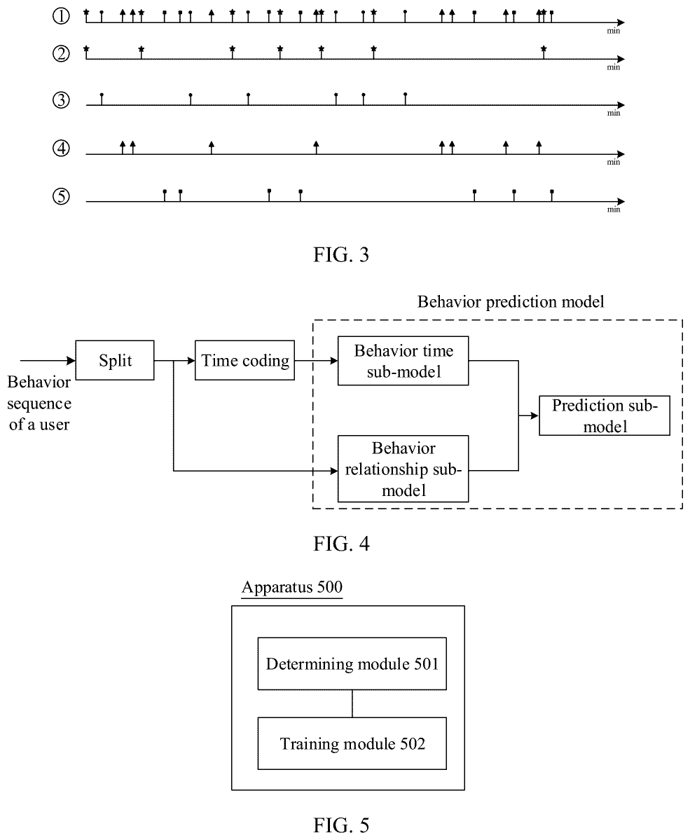

FIG. 3 is a schematic diagram of splitting a behavior sequence of a user according to one or more implementations of the present specification.

For example, FIG. 3 shows multiple single-behavior sequences obtained by splitting the multi-behavior sequence shown in FIG. 1 (e.g., the behavior sequence of the user with a sequence number \textcircled{1}). The multiple behavior types corresponding to the behavior sequence of the user are a pentagonal type, namely, an online purchase type, a circular type, namely, a transfer type, a triangular type, namely, a fund subscription type, and a rectangular type, namely, a chat type. According to the behavior types, the behavior sequence of the user is split into multiple single-behavior sequences, e.g., a sequence with a sequence number \textcircled{2}, a sequence with a sequence number \textcircled{3}, a sequence with a sequence number \textcircled{4}, and a sequence with a sequence number \textcircled{5}, that is, the behavior sequence of the user is split into a behavior sequence of the online purchase type, a behavior sequence of the transfer type, a behavior sequence of the fund subscription type, and a behavior sequence of the chat type.

In step 204, the electronic device performs time coding on the multiple single-behavior sequences to obtain multiple single-behavior time sequences of the multiple single-behavior sequences.

In a possible implementation, step 204 includes: The electronic device performs time coding on the multiple single-behavior sequences by using a trigonometric function, to obtain the multiple single-behavior time sequences.

In the technical solution herein, time coding is performed on the multiple single-behavior sequences by using the trigonometric function, and all time features of each single-behavior sequence in the multiple single-behavior sequences in terms of time can be obtained, so as to obtain multiple single-behavior time sequences of the multiple single-behavior sequences.

For example, the electronic device performs, by using the following equation (1) of the trigonometric function, time coding on each single-behavior sequence in the multiple single-behavior sequences, to obtain the multiple single-behavior time sequences.

$${ϕ}_{T} ( t - τ ) = ε ( t , τ ) = \frac{1}{\sqrt{d}} [ cos ( {ω}_{1} ( t - τ ) + {b}_{1} ) , … , cos ( {ω}_{d} ( t - τ ) + {b}_{d} ) ] \qquad ( 1 )$$

Φ_{T} indicates a mapping of a behavior sequence within a time period; b₁, . . . , b_{d} are phase difference parameters; ω₁, . . . , ω_{d} are frequency parameters; d is a dimension obtained by mapping a behavior sequence by using a trigonometric function; and t-τ indicates a time period.

206. The electronic device inputs the multiple single-behavior time sequences into a behavior prediction model, so the behavior prediction model performs modeling of the time point for each single-behavior time sequence in the multiple single-behavior time sequences to obtain a distribution situation of behaviors corresponding to the multiple single-behavior time sequences in terms of time.

In a possible implementation, step 206 includes: The behavior prediction model performs modeling of a strength value of the time point in a predetermined time period for each single-behavior time sequence in the multiple single-behavior time sequences, to obtain the distribution situation of the behaviors corresponding to the multiple single-behavior time sequences in terms of time.

It should be understood that the technical solution herein is to obtain the distribution situation of the behaviors corresponding to the multiple single-behavior time sequences in terms of time, and is actually to obtain a probability density distribution function of the behaviors corresponding to the multiple single-behavior time sequences in a time period.

It should be understood that the behavior prediction model performs modeling of the strength value of the time point in the predetermined time period for each single-behavior time sequence in the multiple single-behavior time sequences, to obtain the distribution situation of the behaviors corresponding to the multiple single-behavior time sequences in terms of time. For example, a probability density distribution function, as represented by the following equation (2), of the behavior corresponding to each single-behavior time sequence in the multiple single-behavior time sequences in a time period is obtained.

$${p}^{*} ( {τ}_{i} ) := p ( {τ}_{i} \vert {H}_{{t}_{i}} ) = {λ}^{*} ( {t}_{i - 1} + {τ}_{i} ) exp ( - {\int }_{0}^{{τ}_{i}} {λ}^{*} ( {t}_{i - 1} + s ) ds ) \qquad ( 2 )$$

τᵢ indicates a time period; p*(τᵢ) is a probability density distribution function of a behavior corresponding to a single-behavior time sequence in a time period; p*(τᵢ):=p(τᵢ|Hₜ_{ᵢ}) indicates that a probability density distribution function of a behavior corresponding to a single-behavior time sequence in a time period is related to a historical behavior of the single-behavior time sequence; λ*(tᵢ₋₁+τᵢ) is a strength function (strength value) of occurrence of a behavior in a time period from tᵢ₋₁ to τᵢ, that is, a probability of occurrence of the behavior; and s indicates a time point in the time period from tᵢ₋₁ to τᵢ.

In a possible implementation, in a case in which the behavior prediction model includes a behavior time sub-model, step 206 includes: The electronic device inputs the multiple single-behavior time sequences into the behavior time sub-model in the behavior prediction model, so the behavior time sub-model performs modeling of the time point for each single-behavior time sequence in the multiple single-behavior time sequences to obtain the distribution situation of the behaviors corresponding to the multiple single-behavior time sequences in terms of time.

In the technical solution herein, for example, step 206 is implemented as follows: In a case in which the behavior prediction model includes the behavior time sub-model, the multiple single-behavior time sequences can be input into the behavior time sub-model, and the behavior time sub-model performs modeling of the time point for each single-behavior time sequence in the multiple single-behavior time sequences.

208. The electronic device trains the behavior prediction model based on a first loss value between the distribution situation of the behaviors corresponding to the multiple single-behavior time sequences in terms of time and the multiple single-behavior time sequences, the behavior prediction model being used to predict a time point and a type of at least one future behavior of the user based on the behavior sequence of the user.

In a possible implementation, in a case in which the behavior prediction model includes a behavior time sub-model, step 208 includes: The electronic device trains the behavior time sub-model in the behavior prediction model based on the first loss value between the distribution situation of the behaviors corresponding to the multiple single-behavior time sequences in terms of time and the multiple single-behavior time sequences.

In the technical solution herein, in a case in which the behavior prediction model includes the behavior time sub-model, the behavior time sub-model is, for example, trained by using the first loss value between the multiple single-behavior time sequences and the distribution situation of the behaviors corresponding to the multiple single-behavior time sequences in terms of time. The distribution situation of the behaviors corresponding to the multiple single-behavior time sequences in terms of time is obtained by the behavior time sub-model by modeling the time point for the multiple single-behavior time sequences.

In a possible implementation, in a case in which the behavior prediction model further includes a behavior relationship sub-model and a prediction sub-model, the method further includes: The electronic device inputs the multiple single-behavior sequences into the behavior relationship sub-model to obtain causality between every two single-behavior sequences in the multiple single-behavior sequences, where the causality is used to represent a relationship between occurrence of a behavior in one single-behavior sequence and occurrence of a behavior in another single-behavior sequence in every two single-behavior sequences; the electronic device inputs, into the prediction sub-model, the causality between every two single-behavior sequences in the multiple single-behavior sequences and the distribution situation of the behaviors corresponding to the multiple single-behavior time sequences in terms of time, so the prediction sub-model performs sequence prediction based on the causality and the distribution situation to obtain a predicted behavior sequence; and the electronic device trains the behavior relationship sub-model and the prediction sub-model based on the first loss value and a second loss value between the predicted behavior sequence and the behavior sequence of the user.

In the technical solution herein, when the behavior prediction model further includes the behavior relationship sub-model and the prediction sub-model, the multiple single-behavior sequences can be input into the behavior relationship sub-model, to obtain the causality between every two single-behavior sequences in the multiple single-behavior sequences; and the causality between every two single-behavior sequences in the multiple single-behavior sequences and the distribution situation of the behaviors corresponding to the multiple single-behavior time sequences in terms of time are input into the prediction sub-model, so as to obtain the predicted user sequence by using the prediction sub-model. Therefore, the behavior relationship sub-model and the prediction sub-model are trained based on the first loss value and the second loss value between the predicted behavior sequence and the behavior sequence of the user. In some implementations, the behavior prediction model not only pays attention to the time point information of the behavior sequence of the user, but also pays attention to causality between multiple behaviors in the behavior sequence of the user, so the behavior sequence of the user can be more accurately modeled.

In a possible implementation, that the electronic device inputs the multiple single-behavior sequences into the behavior relationship sub-model to obtain the causality between every two single-behavior sequences in the multiple single-behavior sequences includes: The electronic device obtains the causality between every two single-behavior sequences in the multiple single-behavior sequences according to a sum of covariance values of every two single-behavior sequences in the multiple single-behavior sequences at all time points.

It should be understood that the obtaining the causality between every two single-behavior sequences in the multiple single-behavior sequences is, for example, determining Granger causality between every two single-behavior sequences.

It should be further understood that the electronic device obtains, according to the following equation (3) with the Granger causality, the causality between every two single-behavior sequences in the multiple single-behavior sequences.

$${f}_{k} ( {X}_{i} ) - {f}_{k} ( {\overline{X}}_{i} ) = {\sum }_{j = 1}^{i} {A}_{j} ( {f}_{k} , {X}_{i} , {\overline{X}}_{i} ) \qquad ( 3 )$$

Xᵢ and X̅ᵢ are respectively any two different single-behavior sequences in the multiple single-behavior sequences; i is an ith behavior in a single-behavior sequence; any two single-behavior sequences in the multiple single-behavior sequences can form a group of sequences in k groups; fₖ(Xᵢ)−fₖ(X̅ᵢ) indicates Granger causality between two single-behavior sequences in a kth group of sequences; and Aⱼ(fₖ, Xᵢ, X̅ᵢ) indicates a covariance of an ith behavior between two single-behavior sequences in the kth group of sequences.

In a possible implementation, that the electronic device trains the behavior relationship sub-model and the prediction sub-model based on the first loss value and the second loss value between the predicted behavior sequence and the behavior sequence of the user includes: The electronic device determines a third loss value between a prediction label and a real label of the behavior sequence of the user, where the real label is used to indicate real information of the user, and the prediction label is used to indicate information of the user predicted by the prediction sub-model; the electronic device obtains a fourth loss value by averaging the second loss value and the third loss value; and the electronic device trains the behavior relationship sub-model and the prediction sub-model based on the first loss value and the fourth loss value.

In the technical solution herein, in comparison with training of the behavior relationship sub-model and the prediction sub-model based only on the first loss value and the second loss value, the technical solution herein further introduces the third loss value between the prediction label and the real label. The average value between the third loss value and the second loss value is determined as the fourth loss value, and the behavior relationship sub-model and the prediction sub-model are trained based on the first loss value and the fourth loss value. In this solution, the third loss value is introduced, which is equivalent to introducing more information to train the behavior relationship sub-model and the prediction sub-model. As such, the obtained behavior relationship sub-model and prediction sub-model are more accurate.

In a possible implementation, before the electronic device determines the third loss value between the prediction label and the real label of the behavior sequence of the user, the method further includes: The electronic device inputs, into the prediction sub-model, the causality between every two single-behavior sequences in the multiple single-behavior sequences and the distribution situation of the behaviors corresponding to the multiple single-behavior time sequences in terms of time, to obtain the prediction label corresponding to the behavior sequence of the user.

In some implementations, the real label of the behavior sequence of the user can be identity information and/or occupation information of the user.

The user's consent needs to be obtained for obtaining the identity information and/or the occupation information of the user.

In a possible implementation, that the electronic device trains the behavior relationship sub-model and the prediction sub-model based on the first loss value and the second loss value between the predicted behavior sequence and the behavior sequence of the user includes: The electronic device obtains a fifth loss value according to the first loss value and the second loss value; and the electronic device trains the behavior relationship sub-model based on the fifth loss value, and trains the prediction sub-model based on the second loss value.

In a possible implementation, that the electronic device obtains the fifth loss value according to the first loss value and the second loss value includes: The electronic device determines a first value according to a matrix formed by a second-order partial derivation of each weight in the relationship sub-model and a vector formed by each weight in the relationship sub-model; and the electronic device obtains the fifth loss value according to the first value, the first loss value, and the second loss value.

It should be understood that the process herein of determining the first value is implemented by using a Pareto optimality solution principle.

In some implementations, the electronic device obtains the first value according to the following Pareto optimality equation (4).

$$H υ = ∇ f β ∈ cplspan \{ ∇ {f}_{i} \} \qquad ( 4 )$$

H is a matrix formed by a second-order partial derivation of each weight in the behavior relationship sub-model, and is specifically a Hessian matrix; v is the first value; f is a vector value of the behavior relationship sub-model; ∇fᵢ is a target gradient of each weight; and β is a vector value formed by each weight in the behavior relationship sub-model.

In a possible implementation, the method further includes: The electronic device inputs a behavior sequence to be predicted into the behavior prediction model to obtain a time point and a type corresponding to at least one future behavior of the behavior sequence to be predicted as predicted by the behavior prediction model.

The technical solution herein includes a process of using the behavior prediction model obtained through training. A time point and a type corresponding to at least one future behavior of any behavior sequence can be obtained by predicting the behavior sequence by using the trained behavior prediction model.

In a possible implementation, the electronic device splits a user sequence to be predicted according to behavior types to obtain multiple single-behavior user sequences. The electronic device performs time coding on the multiple single-behavior user sequences to obtain multiple single-behavior user time sequences, where the behavior sequence to be predicted includes multiple single-behavior user sequences and multiple single-behavior user time sequences.

In some implementations, that the electronic device performs time coding on the multiple single-behavior user sequences to obtain the multiple single-behavior user time sequences includes: The electronic device performs time coding on the multiple single-behavior user sequences by using a trigonometric function, to obtain the multiple single-behavior user time sequences.

In a possible implementation, the electronic device inputs the multiple single-behavior user time sequences into a behavior time sub-model to obtain a distribution situation of behaviors corresponding to the multiple single-behavior user time sequences in terms of time. The electronic device inputs the multiple single-behavior user sequences into a behavior relationship sub-model, to obtain causality between every two single-behavior user sequences in the multiple single-behavior user sequences. The electronic device inputs the distribution situation and the causality into a prediction sub-model to obtain a time point and a type corresponding to at least one future behavior of the behavior sequence to be predicted.

FIG. 4 is a schematic structural diagram illustrating a behavior prediction model according to one or more implementations of the present specification.

As shown in FIG. 4, a process of obtaining a behavior prediction model is specifically described. As shown in FIG. 4, specifically, a behavior sequence of a user is split to obtain multiple single-behavior sequences. Time coding is performed on the multiple single-behavior sequences to obtain multiple single-behavior time sequences. A behavior time sub-model performs modeling of time points in the multiple single-behavior time sequences to obtain a distribution situation of behaviors corresponding to the multiple single-behavior time sequences in terms of time. The multiple single-behavior sequences are input into a behavior relationship sub-model, and the behavior relationship sub-model obtains causality between every two single-behavior sequences in the multiple single-behavior sequences. A prediction sub-model can predict a predicted behavior sequence and a prediction label according to the distribution situation of the behaviors corresponding to the multiple single-behavior time sequences in terms of time and the causality between every two single-behavior sequences in the multiple single-behavior time sequences.

A first loss value between the multiple single-behavior time sequences and the distribution situation of the behaviors corresponding to the multiple single-behavior time sequences in terms of time is determined; a second loss value between the behavior sequence of the user and the predicted behavior sequence is determined; and a third loss value between a real label and the prediction label is determined.

The behavior time sub-model, the behavior relationship sub-model, and the prediction sub-model can be trained based on the first loss value and the second loss value. Or a fourth loss value can be obtained based on an average value of the second loss value and the third loss value, and the behavior time sub-model, the behavior relationship sub-model, and the prediction sub-model are trained based on the first loss value and the fourth loss value.

FIG. 5 is a schematic structural diagram illustrating an apparatus for training a behavior prediction model according to one or more implementations of the present specification.

For example, as shown in FIG. 5, the apparatus 500 includes: a determining module 501, configured to split a behavior sequence of a user to obtain multiple single-behavior sequences, each single-behavior sequence being corresponding to one behavior, and being used to record a correspondence between the behavior and a time point; the determining module 501 being further configured to perform time coding on the multiple single-behavior sequences to obtain multiple single-behavior time sequences of the multiple single-behavior sequences; the determining module 501 being further configured to input the multiple single-behavior time sequences into a behavior prediction model, so the behavior prediction model performs modeling of the time point for each single-behavior time sequence in the multiple single-behavior time sequences to obtain a distribution situation of behaviors corresponding to the multiple single-behavior time sequences in terms of time; and a training module 502, configured to train the behavior prediction model based on a first loss value between the distribution situation of the behaviors corresponding to the multiple single-behavior time sequences in terms of time and the multiple single-behavior time sequences, the behavior prediction model being used to predict a time point and a type of at least one future behavior of the user based on the behavior sequence of the user.

In some implementations, the determining module 501 is configured to split the behavior sequence of the user according to behavior types to obtain the multiple single-behavior sequences, where the behavior sequence of the user corresponds to multiple behavior types.

In some implementations, the determining module 501 is further configured to perform time coding on the multiple single-behavior sequences by using a trigonometric function, to obtain the multiple single-behavior time sequences.

In some implementations, the determining module 501 is further configured to: perform, by using the behavior prediction model, modeling of a strength value of the time point in a predetermined time period for each single-behavior time sequence in the multiple single-behavior time sequences, to obtain the distribution situation of the behaviors corresponding to the multiple single-behavior time sequences in terms of time.

It should be understood that the solution herein is to obtain the distribution situation of the behaviors corresponding to the multiple single-behavior time sequences in terms of time, and is actually to obtain a probability density distribution function of the behaviors corresponding to the multiple single-behavior time sequences in a time period.

In some implementations, the behavior prediction model includes a behavior time sub-model, and the determining module 501 is further configured to: input the multiple single-behavior time sequences into the behavior time sub-model in the behavior prediction model, and perform, by the behavior time sub-model, modeling of the time point for each single-behavior time sequence in the multiple single-behavior time sequences to obtain the distribution situation of the behaviors corresponding to the multiple single-behavior time sequences in terms of time.

In some implementations, the training module 502 is configured to train the behavior time sub-model in the behavior prediction model based on the first loss value between the distribution situation of the behaviors corresponding to the multiple single-behavior time sequences in terms of time and the multiple single-behavior time sequences.

In some implementations, the behavior prediction model further includes a behavior relationship sub-model and a prediction sub-model, and the determining module 501 is further configured to: input the multiple single-behavior sequences into the behavior relationship sub-model to obtain causality between every two single-behavior sequences in the multiple single-behavior sequences, where the causality is used to represent a relationship between occurrence of a behavior in one single-behavior sequence and occurrence of a behavior in another single-behavior sequence in every two single-behavior sequences; and input, into the prediction sub-model, the causality between every two single-behavior sequences in the multiple single-behavior sequences and the distribution situation of the behaviors corresponding to the multiple single-behavior time sequences in terms of time, and perform, by the prediction sub-model, sequence prediction based on the causality and the distribution situation to obtain a predicted behavior sequence; and the training module 502 is further configured to: train the behavior relationship sub-model and the prediction sub-model based on the first loss value and a second loss value between the predicted behavior sequence and the behavior sequence of the user.

In some implementations, the determining module 501 is further configured to obtain the causality between every two single-behavior sequences in the multiple single-behavior according to a sum of covariance values of every two single-behavior sequences in the multiple single-behavior sequences at all time points.

In some implementations, the training module 502 is further configured to: determine a third loss value between a prediction label and a real label of the behavior sequence of the user, where the real label is used to indicate real information of the user, and the prediction label is used to indicate information of the user predicted by the prediction sub-model; obtain a fourth loss value by averaging the second loss value and the third loss value; and train the behavior relationship sub-model and the prediction sub-model based on the first loss value and the fourth loss value.

In some implementations, the determining module 501 is further configured to: input, into the prediction sub-model, the causality between every two single-behavior sequences in the multiple single-behavior sequences and the distribution situation of the behaviors corresponding to the multiple single-behavior time sequences in terms of time, to obtain the prediction label corresponding to the behavior sequence of the user.

In some implementations, the training module 502 is further configured to: obtain a fifth loss value according to the first loss value and the second loss value; and train the behavior relationship sub-model based on the fifth loss value, and train the prediction sub-model based on the second loss value.

In some implementations, the determining module 501 is further configured to: determine a first value according to a matrix formed by a second-order partial derivation of each weight in the relationship sub-model and a vector formed by each weight in the relationship sub-model; and obtain the fifth loss value according to the first value, the first loss value, and the second loss value.

It should be understood that the process herein of determining the first value is implemented by using a Pareto optimality solution principle.

In some implementations, the determining module 501 is further configured to: input a behavior sequence to be predicted into the behavior prediction model to obtain a time point and a type corresponding to at least one future behavior of the behavior sequence to be predicted as predicted by the behavior prediction model.

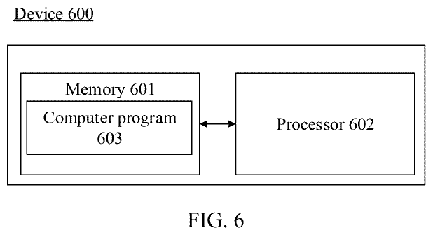

FIG. 6 is a schematic structural diagram illustrating an electronic device, according to one or more implementations of the present specification.

For example, as shown in FIG. 6, the electronic device 600 includes a memory 601, a processor 602, and a computer program 603 stored in the memory 601 and running on the processor 602. When the processor 602 executes the computer program 603, the electronic device can perform any method herein for training a behavior prediction model.

In one or more implementations of the present specification, function modules of the electronic device can be divided according to the method examples herein. For example, the division can be corresponding to each function module, or two or more functions can be integrated into one processing module. The integrated module can be implemented in a form of hardware. It should be noted that module division in one or more implementations of the present specification is an example, and is merely logical function division. In actual implementation, there can be another division manner.

In a case in which each function module is divided by using a corresponding function, the electronic device can include a determining module, a training module, etc. It should be noted that all related content of each step involved in the method implementation herein can be referenced to a function description of a corresponding function module, and details are omitted herein for simplicity.

An electronic device provided in one or more implementations of the present specification is configured to perform the method herein for training a behavior prediction model. Therefore, the same effect as that in the implementation herein method can be achieved.

In a case in which an integrated unit is used, the electronic device can include a processing module and a storage module. The processing module can be configured to control and manage an action of the electronic device. The storage module can be configured to support the electronic device in executing mutual program code, data, etc.

The processing module can be a processor or a controller, and can implement or execute various example logical blocks, modules, and circuits described with reference to content disclosed in one or more implementations of the present specification. The processor can alternatively be a combination that implements a computing function, for example, includes a combination of one or more microprocessors, a combination of a digital signal processor (DSP) and a microprocessor, and the storage module can be a memory.

An electronic device provided in one or more implementations of the present specification can be specifically a chip, a component, or a module, and the electronic device can include a processor and a memory connected to each other. The memory is configured to store instructions. When the electronic device runs, the processor can invoke and execute the instructions, so the chip performs any method herein for training a behavior prediction model.

One or more implementations of the present specification provide a computer-readable storage medium. The computer-readable storage medium stores instructions. When the instructions run on a computer or a processor, the computer or the processor performs any method herein for training a behavior prediction model.

One or more implementations of the present specification further provide a computer program product including instructions. When the computer program product runs on a computer or a processor, the computer or the processor performs the related steps, so as to implement any method herein for training a behavior prediction model.

The electronic device, the computer-readable storage medium, the computer program product including instructions, or the chip that are provided in one or more implementations of the present specification are all used to perform the corresponding method. Therefore, for beneficial effects that can be achieved thereby, references can be made to beneficial effects in the corresponding method. Details are omitted herein for simplicity again.

It can be learned by a person skilled in the art from the descriptions herein of the implementations that for convenience and brevity of description, only division into the functional modules is used as an example for description. In practice, the functions herein can be allocated to different functional modules for implementation according to a requirement. For example, an internal structure of an apparatus is divided into different functional modules, to complete all or some of the functions described herein.

In one or more implementations of the present specification, it should be understood that the disclosed apparatus and method can be implemented in another manner. For example, the described apparatus implementation is merely an example. For example, the module or division into the units is merely logical function division and can be other division in actual implementation. For example, a plurality of units or components can be combined or integrated into another apparatus, or some features can be ignored or not performed. In addition, the displayed or discussed mutual couplings or direct couplings or communication connections can be implemented by using some interfaces. The indirect couplings or communication connections between the apparatuses or units can be implemented in electronic, mechanical, or other forms.

Example implementations of the present specification are described herein. Other implementations fall within the scope of the appended claims. In some cases, actions or steps described in the claims can be performed in an order different from that in the implementations and the desired results can still be achieved. In addition, the process depicted in the accompanying drawings does not necessarily need a particular execution order to achieve the desired results. In some implementations, multi-tasking and concurrent processing are feasible or may be advantageous.

The above content includes only one or more example implementations of the present specification. However, the protection scope of the one or more implementations of the present specification is not limited thereto. Any change or replacement readily figured out by a person skilled in the art within the technical scope disclosed in the one or more implementations of the present specification shall fall within the protection scope of the one or more implementations of the present specification. Therefore, the protection scope of one or more implementations of the present specification shall be subject to the protection scope of the claims.

What is claimed is:

1. A computer-implemented method for training an artificial intelligence based behavior prediction model, comprising:
splitting a behavior sequence of a user to obtain multiple single-behavior sequences, each single-behavior sequence corresponding to a behavior and a time point of the behavior;
performing time coding on the multiple single-behavior sequences to obtain multiple single-behavior time sequences of the multiple single-behavior sequences;
inputting the multiple single-behavior time sequences into a behavior prediction model for the behavior prediction model to perform modeling of a time point for a single-behavior time sequence in the multiple single-behavior time sequences to obtain a distribution in time of behaviors corresponding to the multiple single-behavior time sequences; and
training the behavior prediction model based on a first loss value between the distribution in time of the behaviors corresponding to the multiple single-behavior time sequences and the multiple single-behavior time sequences, the behavior prediction model configured to predict a time point and a type of at least one future behavior of the user based on the behavior sequence of the user.

2. The method according to claim 1, wherein the splitting the behavior sequence of the user to obtain the multiple single-behavior sequences includes:
splitting the behavior sequence of the user based on behavior types to obtain the multiple single-behavior sequences, wherein the behavior sequence of the user corresponds to multiple behavior types.

3. The method according to claim 1, wherein the performing time coding on the multiple single-behavior sequences to obtain the multiple single-behavior time sequences of the multiple single-behavior sequences includes:
performing time coding on the multiple single-behavior sequences by using a trigonometric function, to obtain the multiple single-behavior time sequences.

4. The method according to claim 1, wherein the performing modeling of the time point for the single-behavior time sequence includes:
modeling a strength value of the time point in a determined time period for each single-behavior time sequence in the multiple single-behavior time sequences.

5. The method according to claim 1, wherein the behavior prediction model includes a behavior time sub-model, and the performing modeling of the time point for the single-behavior time sequence in the multiple single-behavior time sequences includes:
performing, by the behavior time sub-model, modeling of the time point for each single-behavior time sequence in the multiple single-behavior time sequences to obtain the distribution in time of the behaviors corresponding to the multiple single-behavior time sequences.

6. The method according to claim 5, wherein the training the behavior prediction model includes:
training the behavior time sub-model based on the first loss value between the distribution in time of the behaviors corresponding to the multiple single-behavior time sequences and the multiple single-behavior time sequences.

7. The method according to claim 5, wherein the behavior prediction model further includes a behavior relationship sub-model and a prediction sub-model, and the method further comprises:
inputting the multiple single-behavior sequences into the behavior relationship sub-model to obtain causality between two single-behavior sequences in the multiple single-behavior sequences, the causality indicating a relationship between occurrence of a behavior in one single-behavior sequence and occurrence of a behavior in another single-behavior sequence in the two single-behavior sequences;
inputting, into the prediction sub-model, the causality between the two single-behavior sequences in the multiple single-behavior sequences and the distribution in time of the behaviors corresponding to the multiple single-behavior time sequences, and performing, by the prediction sub-model, sequence prediction based on the causality and the distribution in time to obtain a predicted behavior sequence; and
training the behavior relationship sub-model and the prediction sub-model based on the first loss value and a second loss value between the predicted behavior sequence and the behavior sequence of the user.

8. The method according to claim 7, wherein the obtaining the causality between the two single-behavior sequences in the multiple single-behavior sequences includes:
obtaining the causality between the two single-behavior sequences in the multiple single-behavior sequences according to a sum of covariance values of every two single-behavior sequences in the multiple single-behavior sequences at all time points.

9. The method according to claim 7, wherein the training the behavior relationship sub-model and the prediction sub-model based on the first loss value and the second loss value between the predicted behavior sequence and the behavior sequence of the user includes:
determining a third loss value between a prediction label and a real label of the behavior sequence of the user, the real label indicating real information of the user, and the prediction label indicating information of the user predicted by the prediction sub-model;
obtaining a fourth loss value by averaging the second loss value and the third loss value; and
training the behavior relationship sub-model and the prediction sub-model based on the first loss value and the fourth loss value.

10. The method according to claim 9, further comprising:
before the determining the third loss value between the prediction label and the real label of the behavior sequence of the user,
inputting, into the prediction sub-model, the causality between the two single-behavior sequences in the multiple single-behavior sequences and the distribution in time of the behaviors corresponding to the multiple single-behavior time sequences, to obtain the prediction label corresponding to the behavior sequence of the user.

11. The method according to claim 9, wherein the training the behavior relationship sub-model and the prediction sub-model based on the first loss value and the second loss value between the predicted behavior sequence and the behavior sequence of the user includes:
obtaining a fifth loss value based on the first loss value and the second loss value; and
training the behavior relationship sub-model based on the fifth loss value, and training the prediction sub-model based on the second loss value.

12. The method according to claim 11, wherein the obtaining the fifth loss value based on the first loss value and the second loss value includes:
determining a first value according to a matrix formed by a second-order partial derivation of each weight in the relationship sub-model and a vector formed by each weight in the relationship sub-model; and
obtaining the fifth loss value based on the first value, the first loss value, and the second loss value.

13. The method according to claim 1, further comprising:
inputting a behavior sequence to be predicted into the behavior prediction model to obtain a time point and a type corresponding to at least one future behavior corresponding to the behavior sequence to be predicted as predicted by the behavior prediction model.

14. A computing system, comprising one or more storage devices one or more processors, and a computer program stored in the one or more storage devices, individually or collectively, wherein when the computer program is executed by the one or more processors, the computer program enables the one or more processors to, individually or collectively, conduct actions including:
splitting a behavior sequence of a user to obtain multiple single-behavior sequences, each single-behavior sequence corresponding to a behavior and a time point of the behavior;
performing time coding on the multiple single-behavior sequences to obtain multiple single-behavior time sequences of the multiple single-behavior sequences;
inputting the multiple single-behavior time sequences into a behavior prediction model for the behavior prediction model to perform modeling of a time point for a single-behavior time sequence in the multiple single-behavior time sequences to obtain a distribution in time of behaviors corresponding to the multiple single-behavior time sequences; and
training the behavior prediction model based on a first loss value between the distribution in time of the behaviors corresponding to the multiple single-behavior time sequences and the multiple single-behavior time sequences, the behavior prediction model configured to predict a time point and a type of at least one future behavior of the user based on the behavior sequence of the user.

15. The computing system according to claim 14, wherein the splitting the behavior sequence of the user to obtain the multiple single-behavior sequences includes:
splitting the behavior sequence of the user based on behavior types to obtain the multiple single-behavior sequences, wherein the behavior sequence of the user corresponds to multiple behavior types.

16. The computing system according to claim 14, wherein the performing time coding on the multiple single-behavior sequences to obtain the multiple single-behavior time sequences of the multiple single-behavior sequences includes:
performing time coding on the multiple single-behavior sequences by using a trigonometric function, to obtain the multiple single-behavior time sequences.

17. The computing system according to claim 14, wherein the performing modeling of the time point for the single-behavior time sequence includes:
modeling a strength value of the time point in a determined time period for each single-behavior time sequence in the multiple single-behavior time sequences.

18. A computer-readable storage medium having computer executable instructions stored thereon, the computer executable instructions, when executed by one or more processors, enabling the one or more processors to, individually or collectively, implement acts including:
splitting a behavior sequence of a user to obtain multiple single-behavior sequences, each single-behavior sequence corresponding to a behavior and a time point of the behavior;
performing time coding on the multiple single-behavior sequences to obtain multiple single-behavior time sequences of the multiple single-behavior sequences;
inputting the multiple single-behavior time sequences into a behavior prediction model for the behavior prediction model to perform modeling of a time point for a single-behavior time sequence in the multiple single-behavior time sequences to obtain a distribution in time of behaviors corresponding to the multiple single-behavior time sequences; and
training the behavior prediction model based on a first loss value between the distribution in time of the behaviors corresponding to the multiple single-behavior time sequences and the multiple single-behavior time sequences, the behavior prediction model configured to predict a time point and a type of at least one future behavior of the user based on the behavior sequence of the user.

19. The computer-readable storage medium according to claim 18, wherein the behavior prediction model includes a behavior time sub-model, and the performing modeling of the time point for the single-behavior time sequence in the multiple single-behavior time sequences includes:
performing, by the behavior time sub-model, modeling of the time point for each single-behavior time sequence in the multiple single-behavior time sequences to obtain the distribution in time of the behaviors corresponding to the multiple single-behavior time sequences.

20. The computer-readable storage medium according to claim 19, wherein the training the behavior prediction model includes:
training the behavior time sub-model based on the first loss value between the distribution in time of the behaviors corresponding to the multiple single-behavior time sequences and the multiple single-behavior time sequences.
